(19) United States
(12) Patent Application Publication
(10) Pub. No.: US 2012/0036050 A1
(43) Pub. Date: Feb. 9, 2012

(54) STRUCTURING METHOD AND ASSOCIATED MODELING SOFTWARE FOR TAX CREDIT INVESTMENTS THAT WILL GENERATE POSITIVE EARNINGS BEFORE INCOME TAX DEPRECIATION AND AMORTIZATION (EBITDA) UNDER GENERALLY ACCEPTED ACCOUNTING PRINCIPALS (GAAP)

(75) Inventor: Jason Paul NORRIS, Huntersville, NC (US)

(73) Assignee: TCIP Holdings, LLC

(21) Appl. No.: 12/850,302

(22) Filed: Aug. 4, 2010

(51) Int. Cl. G06Q 40/00; G06Q 90/00

(52) U.S. Cl. 705/30; 705/500

(57) ABSTRACT

Low-income housing projects generate federal low-income housing tax credits. Previously, due to numerous impediments, investing in tax credits results in a negative, or at best a neutral effect on the investor's EBITDA for financial accounting purposes. The present invention relates a method that allows for a more efficient syndication of the available tax credits that generates positive EBITDA to investors at a lower cost.

### FIELD OF THE INVENTION

The present invention relates generally to a method of assessing, structuring, and documenting complex financial transactions entered into by companies that are required to keep audited financial statements. In particular, it relates to assessing, structuring, and documenting the investment in federal low-income housing tax credits generated by various real estate projects, as well as the use of associated computer software to model such a structure. The method provides for a GAAP-efficient structure for acquisition and utilization of credits generated by the real estate projects. The software mathematically models the working of such a structure and optimizes the structure.

### BACKGROUND OF THE INVENTION

The Low-Income Housing Tax Credit program, created as part of the Tax Reform Act of 1986, is one of the federal government's most important tools for the development of affordable rental housing. Third-party equity investors receive low-income housing tax credits under section 42 of the Internal Revenue Code (“LIHTC” or “tax credits”) over a 10-year period against federal income taxes owed in return for providing funds to real estate developers to help build or renovate multifamily housing for low-income families (real estate projects (“Projects”)). This capital subsidy allows rents to be set below the cost of developing and maintaining the property. The LIHTC gives tax credit investors who would otherwise never invest in affordable housing an economic incentive to do so.

Currently, investments by companies in most LIHTC transactions are reported for financial accounting purposes under either the “equity method” or under the “effective yield method” of accounting. Each has drawbacks to investors.

The equity method is inexpensive and simple to employ, but produces a significant negative impact on a tax credit investor's “earnings before interest, taxes, depreciation and amortization,” (EBITDA). EBITDA is commonly used by the financial markets to evaluate the performance of a publically traded company and generally has a direct impact on the company's stock price. In a LIHTC investment, an investor (usually a public company) typically makes a substantial cash investment at closing and receives substantial federal income tax benefits in the form of an annual allocation of LIHTC every year for ten consecutive years and federal income tax depreciation losses over a 15 year period. The investor does not typically receive any of its invested cash back. In effect, the invested cash is paid back to the investor (thereby generating the investor's economic return) in the form of LIHTC and depreciation losses, which can be offset against taxable income and reduce the investor's income tax liability.

For financial accounting purposes, the equity method accounts for the fact that an investor makes a substantial cash investment, yet expects to receive none of that cash back, by reflecting on the investor's financial statements an annual diminution in value of the up-front cash investment. This has the effect of reducing the investor's EBITDA each year by the amount that the value of the investment is deemed for financial accounting purposes to diminish that year (referred to as a so-called “above the line” reduction in that it reduces EBITDA).

The equity method also requires the investor to reflect on its financial accounting statements the receipt of the tax credits and losses as an annual flow of tax benefits resulting to the investor, in the form of a reduction in income taxes deemed payable for financial accounting purposes (a so-called “below the line” benefit). In other words, the benefit of the tax benefits consisting of tax credits and depreciation losses is reflected in the reduction in current and future federal income taxes payable by the investor.

Because the calculation of EBITDA ignores the effect of income taxes owed (because EBITDA is by its definition a calculation that is made BEFORE the application of income taxes to a company's earnings), “below the line” tax benefits do not generate positive EBITDA. Because the public stock markets tend to use EBITDA as a financial performance metric for public companies, reductions in EBITDA are deemed undesirable by tax credit investors.

The Effective Yield Method (set forth in Emerging Issues Task Force (EITF) issue No. 94-1) is different than the equity method in that the Effective Yield Method treats the tax credit investment as having no impact (positive or negative) on EBITDA. Instead, the Effective Yield Method nets the dimunition of value in the cash investment against the positive effect of the stream of tax benefits, which consists of the LIHTC and depreciation losses. In effect, the Effective Yield Method results in a reduced positive benefit “below the line” and no negative effect on EBITDA.

A major drawback of the Effective Yield Method is that it is not available for all tax credit transactions. EITF No. 94-1 sets forth three conditions that an investor must meet to use the Effective Yield Method: (1) the availability of the tax credits (but not necessarily the ability of the investor to use the tax credits) allocable to the investor is guaranteed by a creditworthy entity through a bank letter of credit, a tax indemnity agreement, or another similar arrangement; (2) the investor's projected investment yield (i.e. their annualized economic return) based solely on the receipt of guaranteed tax credits must be positive (in other words, the price of the tax credits must be less than $1 per credit dollar); and (3) the investor must be a limited partner in an affordable housing project for both legal and federal income tax purposes, and the investor's economic liability for economic losses resulting from its investment in a housing project must be limited to its capital investment.

Because the guaranty described in (1) above requires a full guaranty of all tax credits, electing the Effective Yield Method comes at a substantial economic cost to the investor. To elect the Effective Yield Method, an investor must obtain a full financial guaranty of the tax credits from a credit worthy entity, such as a bank, which charges for said guarantee. The cost of such a guaranty can reduce the annual IRR of the investment by anywhere between three and five percent. Therefore, a method that would allow an investor to use one accounting method for financial accounting purposes, but use a different method to qualify for the tax credits under the Internal Revenue Code and that allows the investor to report positive EBITDA without a full guaranty of tax credits would reduce the cost of investment in Projects and incentivize investment in affordable housing.

### SUMMARY OF THE INVENTION

One aspect of the present invention assesses and documents a hybrid structure that allows tax credit investments to be treated as debt instruments for financial accounting purposes, while preserving the ability of the tax credit investor to claim all tax benefits generated by the investment. The structure includes a newly formed company (“Newco”), which claims the tax credits. Newco is consolidated with the investor for federal income tax purposes, but not consolidated with Newco for financial accounting purposes.

An effect of a structure according to one embodiment of the invention is to allow tax credit investors to achieve positive EBITDA from its investment (the equivalent to being paid interest and principal on a bond) without the expense associated with a full bank guaranty of the tax credits required under the Effective Yield Method. This embodiment thereby produces a better EBITDA result that the Effective Yield Method and at a substantially lower cost to the investor than the Effective Yield Method.

According to another embodiment of the invention, a method is provided to assess and effect the transfer of federal low-income housing tax credits generated by housing tax credit projects to an investor in such a manner that the investment is treated as a debt instrument for financial accounting purposes. According to this embodiment of the invention, the investor's yield on the tax credit investment is earned for financial accounting purposes in the form of interest payments on a self-amortizing debt instrument, generating positive EBITDA. Nonetheless, for federal income tax purposes, the investor would be deemed to own preferred stock, would be consolidated with Newco, and would continue to be entitled to claim all tax credits and losses associated with its investment in the same manner as it would were it using the equity method or Effective Yield Method. According to this embodiment of the invention, a full guaranty of the tax credits would not be necessary, thereby reducing costs to the investor as compared to a transaction employing the Effective Yield Method and allowing the syndication of a wider range of projects.

The method may include identifying a housing project (or pool of projects) with tax credits available for syndication and determining a corporate structure with one or more corporations for effecting the syndication of the tax credits. Then, various enforceable agreements are documented, including transferring value from a tax credit investor to a newly formed corporation in exchange for preferred stock in the corporation, and the making of various elections that cause the tax benefits to become claimable by the investor. These agreements are at least partially carried out.

More than 80% of the value and the voting rights of the Newco Corporation must be held by the investor for effective tax consolidation. The remaining interest in Newco Corporation in the form of all the common stock of Newco Corporation may be held by another investor (the “Syndicator”). The Syndicator may choose to provide a limited guaranty (the “Limited Guaranty”) of a portion of any potential loss of tax benefits, thereby causing (1) the Syndicator, as the holder of the common stock and the provider of the Limited Guaranty to be consolidated with the Newco Corporation for financial accounting purposes but not to be consolidated with the Newco Corporation for federal income tax purposes, and (2) the investor, as the holder of the preferred stock and the primary beneficiary of the Limited Guaranty to be consolidated with the Newco Corporation for federal income tax purposes but not to be consolidated with the Newco Corporation for financial accounting purposes.

A method according to an embodiment of the invention may further include the use of a tax sharing payment in which members of a consolidated group of corporations (“Tax Benefit Recipient Members”) that have received tax benefits that result from the activities of other members of the consolidated group (“Tax Benefit Generating Members”) to reimburse the Tax Benefit Generating Members for the amount of the tax benefits. The investor may make tax sharing payments to the Newco Corporation to reimburse the Newco Corporation for the tax benefits transferred to the investor.

An embodiment of the method may further include the payment of preferred dividends on the preferred stock to the investor. Although the preferred dividends would be not immediately recognized within the consolidated group for federal income tax purposes, such preferred dividends would generate a deemed benefit to the investor for financial accounting purposes. The method may involve the treatment of the preferred stock as a debt instrument for financial accounting purposes and the treatment of dividend payments on the preferred stock to be treated as interest and principal payments on a debt instrument for financial accounting purposes.

An embodiment of the method may further include collecting information related to the project and calculating the effects of this information upon the related economics, such as the cash flow, profits, capital gains, and depreciation of the project. These calculations may be used to optimize the agreements, including maximizing the available syndicatable tax credits. Further, these calculations may be performed by a computer program.

In another embodiment of the present invention, a computer software program is provided that serves to perform calculations related to the syndication of federal low-income housing tax credits generated by tax credit projects. The computer program generates output related to economic factors that may affect the syndicatability of the tax credits, the structure of the corporate entities, the amount of the tax sharing payments and dividends on the preferred stock, or the form of documents and agreements involved in the syndication of the tax credits. These economic factors may include the tax credits, depreciation and losses expected to be generated, and the amount of any income or losses expected to be generated upon the withdrawal of the Newco Corporation from the tax credit partnership. Further, these calculations may be used to optimize the structuring agreement, including maximizing available syndicatable tax credits and ensuring that the respective value of the common stock held by the Syndicator and the preferred stock held by the investor would not cause the Newco Corporation to be deconsolidated for federal income tax purposes from the investor.

The program's input variables may relate to either the project or the syndication of the tax credits associated with the project. Examples of such variables include development information, tax credit information, debt parameters, fair market value information, tax depreciation information, information relating to the amortization of deferred costs, and cash flow projections. Additionally, the program may allow a user to provide input regarding a desired corporate structure for effecting the syndication of the tax credits and ensuring the proper financial accounting treatment of the transaction.

From these inputs, the program may generate models based upon the gathered information. For example, these models may take the form of charts, graphs, or tables. These representations may convey information about, for example, investor capital accounts, developer capital accounts, benefits to developers, 15-year projections of the net operating income, taxable income, and net cash flow, investor tax credit valuation, investor cash valuation, and summaries of investor valuation.

Another embodiment of the present invention provides a method for assessing the transfer of federal low-income housing tax credits generated by housing tax credit projects to a qualified recipient. The method presented in this embodiment serves to gather information related to a building project and determine the capability for syndication of any tax credits that may be available. First, any economic and predetermined structural factors that may effect the syndicatability of the tax credits are determined, as well as a desired corporate structure, and assumptions related to those involved in the project or the syndication of the tax credits. If the project is determined to be feasible, economic projections resulting from the economic factors and the desired corporate structures may be calculated. These economic factors may include cash flow, profits, capital gains, and depreciation of the project.

Based upon this information, the structure of the corporate structure, the amount of tax sharing payments and the schedule of payments on the preferred stock, as well as the amount of the guaranty needed to be provided by the Syndicator, as well as the agreements among the various parties may be determined by selecting from among predetermined structural alternatives. These alternatives may be related to basic legal structure, type of project, number of projects being syndicated, profit and loss allocation, net cash flow distribution, and residual cash distribution. Economic factors related to the assessment of the project may be determined based upon information related to project development, tax credits, debt parameters, fair market value, tax depreciation, amortization of deferred costs, and cash flow projection. Additionally, these factors may include assumptions related to a syndicator and a tax credit investor.

This information may be collected and used to generate models, which may in turn be based upon the economic factors, the predetermined structural factors, or the desired corporate structure. These models may take the form of, for example, charts, tables, or graphs.

In another embodiment of the present invention, a method for syndicating credits from projects largely solves the financial accounting problems associated with investments in low-income housing projects. In particular, the negative financial accounting and economic issues associated with the use of the equity method and the Effective Yield Method are minimized or eliminated, and an efficient and less expensive means of syndicating the maximum amount of credits (up to 99.9%) in a manner than generates a positive effect to the EBITDA of the investor is created.

A software program may be used to analyze the economics of a particular project or group of projects, including but not limited to, the amount and timing of tax credits, the amount and timing of expected losses, and the amount and timing of any potential gain or loss upon the exit of the investor from the tax credit investment. The program would specify an optimal structure for the syndication of a particular project, the amount of the investment by the investor, the amount of the tax sharing payments, the amount and timing of the dividends on the preferred stock as well as the terms of the documents to be drafted, as discussed below.

Methods according to the present invention may be accomplished as follows. First, a project or series of projects is analyzed, for example with a computer, to determine whether the credits are capable of being syndicated, which alternatives would be optimal to syndicate the credits, whether the invention can be efficiently utilized with respect to the project or projects, the necessary terms of the preferred stock in Newco Corporation to be held by the investor (including the amount of and timing of dividends on the preferred stock), the amount and terms of the guaranty necessary to be provided by the Syndicator to allow the investment by the investor in Newco Corporation to be treated as a debt instrument for financial accounting purposes and for the investor not to be consolidated with the Newco Corporation for financial accounting purposes, the amount and timing of the tax sharing payments to be provided by the investor to Newco Corporation, and the appropriate inputs to the creation of documents to establish the syndication.

Second, the Newco Corporation is organized and a commitment is received from the tax credit investor to invest a certain amount of cash in the syndication company, which may be determined by the software (the “Syndication Investment”). The Syndication Investment is contributed to the Newco Corporation.

Third, the terms of the preferred stock to be held by the investor in Newco Corporation is agreed to by the investor.

In one embodiment of the present invention, a method of assessing and effecting the transfer of federal tax credits generated by low-income housing projects to a recipient capable of utilizing the tax credits and losses, the method may comprise identifying one or more housing projects with tax credits available for syndication, determining a corporate structure for effecting the syndication of the tax credits, determining the yield of the one or more projects, determining terms of common stock and preferred stock in a new corporation, wherein the terms may include a schedule of an investor's preferred stock in the new corporation such that the investor and the new corporation are consolidated for federal income tax purposes and the new corporation and a syndicator are consolidated for financial accounting purposes, documenting enforceable agreements transferring value from the investor to the new corporation, transferring value from the new corporation to an owner of the one or more projects, and transferring at least a portion of the tax credits from the owner to the new corporation, and at least partly carrying out said agreements. In another embodiment of the present invention, the terms may include a dividend rate and the schedule is configured such that the investor receives a specified yield.

In a another embodiment of the present invention, the method further comprises determining the amount of a guaranty to be provided by the syndicator necessary to ensure that the investor's investment in stock is treated as a debt instrument for financial accounting purposes. In a further embodiment, the amount of the guaranty may be further determined by value-based economic factors. The method may further comprise determining the amount of a guaranty to be provided by a guarantor to the syndicator.

In another embodiment the method may further comprise determining the amount of a guaranty to be provided by a guarantor to the syndicator. In another embodiment, the method may further comprise receiving project inputs and calculating the effects of value-based economic factors. In one embodiment, the economic factors may include cash flow, profits, capital gains, depreciation, and internal rate of return to the investor of the project. In one embodiment, the calculations may be used to optimize the agreements, including maximizing available syndicatable tax credits. The calculations may be performed by a computer program.

In another embodiment, a computer software program having computer program logic therein may cause a computer to receive inputs associated with the transfer of federal low-income housing tax credits generated by a low-income housing tax credit project and determine output related to economic factors that affect at least one of the syndicatability of the tax credits, the structure of corporations involved in the syndication of the tax credits, the terms of the preferred stock and common stock in a new corporation, the terms, amount and timing of the tax sharing payments to be made by an investor to the new corporation, and the form of documents and agreements. In one embodiment the economic factors may include cash flow, profits, capital gains, and intended internal rate of return of the project. In one embodiment the computer program may cause a computer to perform calculations to optimize the corporate structure, including maximizing available syndicatable tax credits. In one embodiment the inputs may comprise one or more variables relating to at least one of the projects and the syndication of the tax credits. In another embodiment the variables may comprise one or more of development information, tax credit information, debt parameters, fair market value information, tax depreciation information, information relating to the expected loss performance of the projects, estimated gain or loss upon the departure of the investor from the new corporation, and cash flow projections. In a further embodiment the variables may comprise one or more of total project development costs, tax credits, parameters of the debt, fair market value, tax depreciation, amortization of deferred costs, required yield on the tax credit investor, tax rate, ownership percentages, numbers of shares of stock, present value, term, and cash flow projections.

In one embodiment of the present invention, a computer may allow a user to provide input regarding desired corporate structure. In one embodiment of the present invention a computer may output models. The models may comprise at least one of graphs, charts, and tables. In one embodiment one or more models may convey information about one or more of investor capital accounts, developer capital accounts, benefits to developers, 15-year projections of the net operating income, taxable income, and net cash flow, investor tax credit valuation, investor cash valuation, pricing and terms of the preferred stock and common stock in the new corporation, and the expected gain or loss upon the exit of the investor from the new corporation.

### BRIEF DESCRIPTION OF THE DRAWINGS

FIG. 1 depicts a flow chart detailing one implementation of the computer software used to model the structure, according to an embodiment of the present invention.

FIG. 2 depicts potential project development inputs to the computer model, according to an embodiment of the present invention.

FIG. 3 depicts typical outputs produced by the computer model, according to an embodiment of the present invention.

FIG. 4 depicts an exemplary ownership structure, according to an embodiment of the present invention.

FIG. 5 depicts an exemplary ownership structure, according to an embodiment of the present invention.

FIG. 6 depicts an exemplary ownership structure, according to an embodiment of the present invention.

FIG. 7 depicts an exemplary ownership structure, according to an embodiment of the present invention.

### DETAILED DESCRIPTION OF THE PREFERRED EMBODIMENTS

The present invention relates to a method and provides for a more efficient structure for the development of new and existing low-income projects, as well as a more effective means of utilizing new and existing tax credits associated with such projects, according to an embodiment of the invention.

In a preferred embodiment if the invention, federal low-income housing tax credits generated by low-income housing projects are transferred to an investing company (the “investor”) in such a manner that the investment is treated as a debt instrument for financial accounting purposes. The investor's yield on the tax credit investment is earned for financial accounting purposes in the form of interest payments on a self-amortizing debt instrument, which generates positive EBITDA. Nonetheless, for federal income tax purposes, the investor would continue to be entitled to claim all tax credits and losses associated with its investment in the same manner as it would were it employing a conventional investment structure and using the equity method or Effective Yield Method. A full guaranty of the tax credits would not be necessary, thereby reducing costs to the investor as compared to a transaction employing the Effective Yield Method and allowing the syndication of a wider range of projects.

The method includes identifying a housing project with tax credits available for syndication and determining a corporate structure with one or more corporations for effecting the syndication of the tax credits. Then, various enforceable agreements are documented, including transferring value from an investor to a newly formed corporation (“Newco Corporation”) in exchange for preferred stock in the corporation, and the making of various elections that cause the tax benefits to become claimable by the investor. These agreements are at least partially carried out.

The agreements can be structured as follows. More than 80% of the value and the voting rights of the Newco Corporation are held by the investor. In one embodiment, the company holding the greater than 80% value and voting rights of the Newco Corporation is a wholly-owned subsidiary of another company. The remaining interest in Newco Corporation in the form of all the common stock of Newco Corporation may be held by another investor (the “Syndicator”).

In a preferred embodiment, the valuation of the assets of the Newco Corporation consists of a limited partnership interest (commonly 99.99%) in the limited partnership or limited partnerships (LP) that owns the rental property. Stock in the Newco Corporation is split into Common and Preferred shares. The Preferred Stock in the Newco Corporation is entitled to a specific set of payments and will have a relatively fixed value. The Common Stock in the Newco Corporation has a value that will float upward and downward based upon the value of the assets of the Newco Corporation. For example, if the value of the assets of the Newco Corporation are worth $1 million and the Preferred Stock is worth $950,000, the Common Stock will be worth $50,000. If the value of the assets of the Newco Corporation drop to $950,000, the Common stock will be worth close to zero and the Preferred Stock will still be worth $950,000.

On the other hand, if the assets of the Newco Corporation appreciate in value to $2 million, the Preferred Stock will still be worth $950,000, but the Common Stock will now be worth $1,050,000.

The Internal Revenue Code and underlying Treasury Regulations provide that the Newco Corporation will be consolidated with the Preferred Stock holder (the investor) only where the Preferred Stock holder possess more than 80% of the voting control of all classes of voting stock and more than 80% of the value of all classes of stock. Because the value of the Common Stock fluctuates and the value of the Preferred Stock is constant, it is necessary to value the assets of the Newco Corporation (consisting of the LP interests in underlying tax credits investments) on an annual basis to confirm that the value of the common stock has not appreciated by an amount that would cause the Common Stock to constitute more than 20% of the value of all the stock of the NewCo Corporation (Preferred and Common combined). Because the value of the tax credits and losses tends to be very predictable and should decrease in value over time (as the tax credit stream is exhausted) rather than increase in value, a value for the Preferred Stock may be calculated such that the NewCo Corporation may be consolidated with the Preferred Stock holder (the investor) under the Internal Revenue Code and Treasury Regulations each year the tax credits are available from the Project. The model of the present invention calculates the value of the common and preferred stock necessary to meet this test.

As explained above, electing the Effective Yield Method comes at a substantial economic cost to the investor. To elect the Effective Yield Method, an investor must obtain a full financial guaranty of 100% of the tax credits from a credit worthy entity, such as a bank, which charges for said guaranty. The cost of such a guaranty can often reduce the annual IRR of the investment by anywhere between three and five percent.

In a preferred embodiment, to ensure that the NewCo Corporation will be consolidated with the Syndicator for Book/GAAP (financial accounting) purposes, the economic risk of loss of the assets of the NewCo Corporation must be borne by the Common Stock holder (the Syndicator) rather than the Preferred Stock holder (the investor). This is accomplished by the Syndicator guaranteeing a certain amount (but not all) of the Tax Credits. The required amount of the guaranty is the reasonable expected losses of the NewCo Corporation. For example, if historically 2% of all tax credits available for the life of a project are lost due to default, the Syndicator may provide a guaranty of up to $2 million on a $100 million tax credit fund calculated to be available from a particular project or series of projects. This is to be contrasted with the Effective Yield Method of Accounting which would require the Investor to obtain a Guaranty on 100%, or in the above example, $100 million of future expected Tax Credits, which guaranty will be far more expensive to obtain from a third party (e.g. a bank or other financial institution), or for an individual Syndicator to provide through its own guaranty.

The Syndicator may choose to provide a limited guaranty (the “Limited Guaranty”) of a portion of any potential loss of tax benefits, thereby causing (1) the Syndicator, as the holder of the common stock and the provider of the Limited Guaranty to be consolidated with the Newco Corporation for financial accounting purposes but not to be consolidated with the Newco Corporation for federal income tax purposes, and (2) the investor, as the holder of the preferred stock and the primary beneficiary of the Limited Guaranty to be consolidated with the Newco Corporation for federal income tax purposes but not to be consolidated with the Newco Corporation for financial accounting purposes.

In the above example, if the Syndicator provides its own guaranty of the expected tax credit losses, in a preferred embodiment it will pay some other creditworthy entity such as a bank to provide a guaranty to it in the event it is required to pay on its guaranty. This is referred to herein as a “Backup Guaranty”. Two examples of providers of such a Backup Guaranty are an unrelated third party such as a bank, or, in an alternative embodiment, the General Partner of the Limited Partnership, who may be the developer of the project, may provide the Backup Guaranty.

Whether there is a Backup Guaranty or not, the provision of the guaranty by the Syndicator, coupled with the Investor holding mandatorily redeemable preferred stock (which is treated as a debt instrument for GAAP purposes) causes the Investor to be treated as having made a loan to the Subsidiary for GAAP purposes and causes income and financial accounting losses of the Subsidiary to be consolidated for GAAP purposes with the Syndicator rather than the Investor.

It is possible for a portion of the members of a consolidated group of corporations (“Tax Benefit Recipient Members”) that have received tax benefits that result from the activities of other members of the consolidated group (“Tax Benefit Generating Members”) to reimburse the Tax Benefit Generating Members for the amount of the tax benefits in the form of a tax sharing payment equal economically to the value of the tax benefits. In this structure, the investor may make tax sharing payments to the Newco Corporation to reimburse the Newco Corporation for the tax benefits transferred to the investor.

In addition, preferred dividends on the preferred stock may be made to the investor. Although the preferred dividends would not generate taxable income within the consolidated group for federal income tax purposes, such preferred dividends would generate a benefit to the investor for financial accounting purposes. For financial accounting purposes the preferred stock would be treated as a debt instrument and the dividend payments on the preferred stock would be treated as interest and principal payments on that debt instrument.

In a preferred embodiment of the invention, information related to the project is collected and the effects of this information upon the related economics is calculated, such as the cash flow, profits, capital gains, and depreciation of the project. These calculations may be used to optimize the agreements, including maximizing the available syndicatable tax credits. Further, these calculations may be performed by a computer program.

In another embodiment of the present invention, a computer software program is provided that serves to perform calculations related to the syndication of federal low-income housing tax credits generated by tax credit projects. The computer program generates output related to economic factors that may affect the syndicatability of the tax credits, the structure of the corporate entities, the amount of the tax sharing payments and dividends on the preferred stock, or the form of documents and agreements involved in the syndication of the tax credits. These economic factors may include the tax credits, depreciation and losses expected to be generated, the amount of any income or losses expected to be generated upon the withdrawal of the Newco Corporation from the tax credit partnership. Further, these calculations may be used to optimize the structuring agreement, including maximizing available syndicatable tax credits and ensuring that the respective value of the common stock held by the Syndicator and the preferred stock held by the investor would not cause the Newco Corporation to be deconsolidated for federal income tax purposes from the investor.

The program's input variables may relate to either the project or the syndication of the tax credits associated with the project. Examples of such variables include development information, tax credit information, debt parameters, fair market value information, tax depreciation information, information relating to the amortization of deferred costs, and cash flow projections. Additionally, the program may allow a user to provide input regarding a desired corporate structure for effecting the syndication of the tax credits and ensuring the proper financial accounting treatment of the transaction. For example, if the Internal Revenue Code and Treasury Regulations regarding ownership of projects eligible for LIHTC change, variables related to the maximum or minimum ownership of an entity can be altered.

From these structural inputs, the program may generate models based upon the gathered information. For example, these models may take the form of charts, graphs, or tables. These representations may convey information about, for example, investor capital accounts, developer capital accounts, benefits to developers, 15-year projections of the net operating income, taxable income, and net cash flow, investor tax credit valuation, investor cash valuation, and summaries of investor valuation.

Another embodiment of the present invention provides a method for assessing the transfer of federal low-income housing tax credits generated by low-income housing tax credit projects to a qualified recipient. The method presented in this embodiment serves to gather information related to a building project and determine the capability for syndication of any tax credits that may be available. First, any economic and predetermined structural factors that may effect the syndicatability of the tax credits are determined, as well as a desired corporate structure, and assumptions related to those involved in the project or the syndication of the tax credits. If the project is determined to be feasible, economic projections resulting from the economic factors and the desired partnership structures may be calculated. These economic factors may include cash flow, profits, capital gains, and depreciation of the project.

Based upon this information, the corporate structure, the amount of tax sharing payments and the schedule of payments on the preferred stock, as well as the amount of the guaranty needed to be provided by the Syndicator (or third-party guarantor), as well as the agreements among the various parties may be determined by selecting from among predetermined structural alternatives. These alternatives may be related to basic legal structure, type of project, number of projects being syndicated, profit and loss allocation, net cash flow distribution, and residual cash distribution. Economic factors related to the assessment of the project may be determined based upon information related to project development, tax credits, debt parameters, fair market value, tax depreciation, amortization of deferred costs, and cash flow projection. Additionally, these factors may include assumptions related to a syndicator and a tax credit investor.

This information may be used to generate models, which may in turn be based upon the economic factors, predetermined structural factors, or the desired NewCo Corporate structure. These models may take the form of, for example, charts, tables, or graphs.

The manner of syndicating tax credits from projects of the present invention mitigates certain of the financial accounting impediments associated with investments in low-income housing projects. In particular, the negative financial accounting and economic issues associated with the use of the equity method and the Effective Yield Method are minimized or eliminated, and an efficient and less expensive means of syndicating the maximum amount of credits in a manner than generates a positive effect to the EBITDA of the investor is created.

A software program may be used to analyze the economics of a particular project or group of projects, including but not limited to, the amount and timing of tax credits, the amount and timing of expected losses, and the amount and timing of any potential gain or loss upon the exit of the investor from the tax credit investment. The program would specify an optimal structure for the syndication of a particular project, the amount of the investment by the investor, the amount of the tax sharing payments, the amount and timing of the dividends on the preferred stock as well as the terms of the documents to be drafted, as discussed below.

Methods according to the present invention may be accomplished as follows. First, a project or series of projects is analyzed, for example with a computer, to determine whether the credits are capable of being syndicated, which alternatives would be optimal to syndicate the credits, whether the invention can be efficiently utilized with respect to the project or projects, the necessary terms of the preferred stock in Newco Corporation to be held by the investor (including the amount of and timing of dividends on the preferred stock), the amount and terms of the guaranty necessary to be provided by the Syndicator (or third-party guarantor) to allow the investment by the investor in Newco Corporation to be treated as a debt instrument for financial accounting purposes, the amount and timing of the tax sharing payments to be provided by the investor to Newco Corporation, and the appropriate inputs to the creation of documents to establish the syndication.

Second, the Newco Corporation is organized and a commitment is received from the tax credit investor to invest a certain amount of cash in the syndication company, which may be determined by the software (the “Syndication Investment”). The Syndication Investment is contributed to the Newco Corporation.

Third, the terms of the preferred stock to be held by the investor in Newco Corporation is agreed to by the investor.

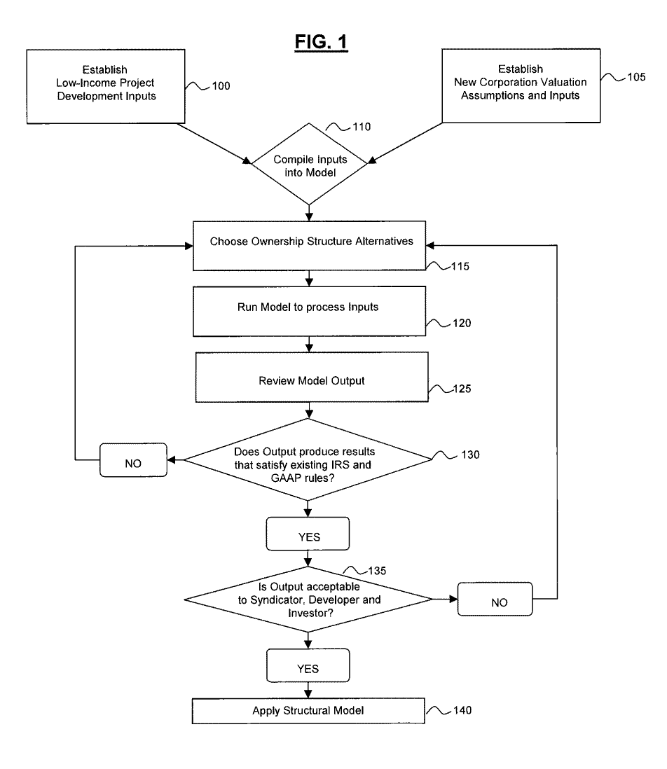

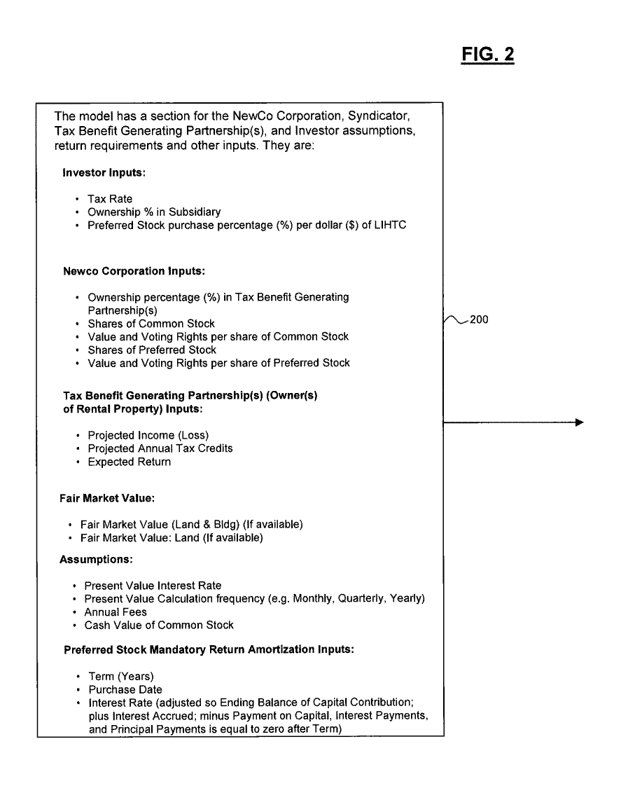

FIG. 1 is a flow chart that depicts an embodiment of the present invention, a method of assessing a hybrid structure that allows tax credit investments to be treated as debt instruments for financial accounting purposes, while preserving the ability of the tax credit investor to claim all tax benefits generated by the investment, and documenting such a structure. Referring to FIG. 1, in step 100 and 105, a computer or a computer program, for example, collects and inputs variables associated with a given low-income project with tax credits available for syndication. In step 100, the inputs comprise project development inputs. In step 105, the inputs comprise assumptions regarding the tax credit syndicator and tax credit investor. These inputs generally relate to economic details of housing projects, for example, those shown in FIG. 2. For example, the inputs in step 100 may include information regarding the total project development costs, tax credits, parameters of the debt, fair market value, tax depreciation, amortization of deferred costs, required yield on the tax credit investor, tax rate, ownership percentages, numbers of shares of stock, present value, term, and cash flow projection, among others.

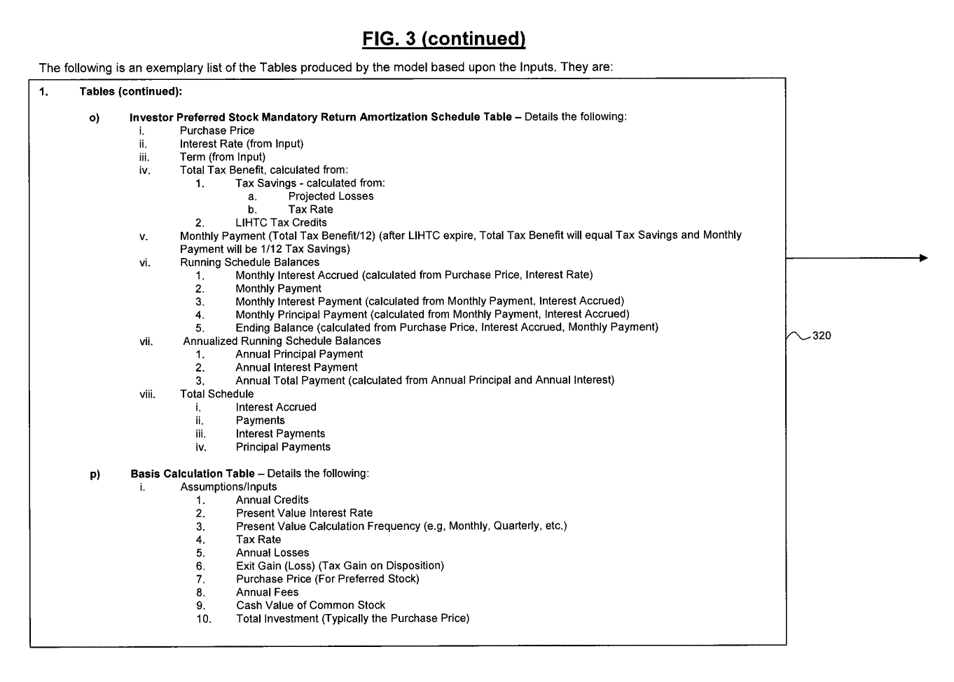

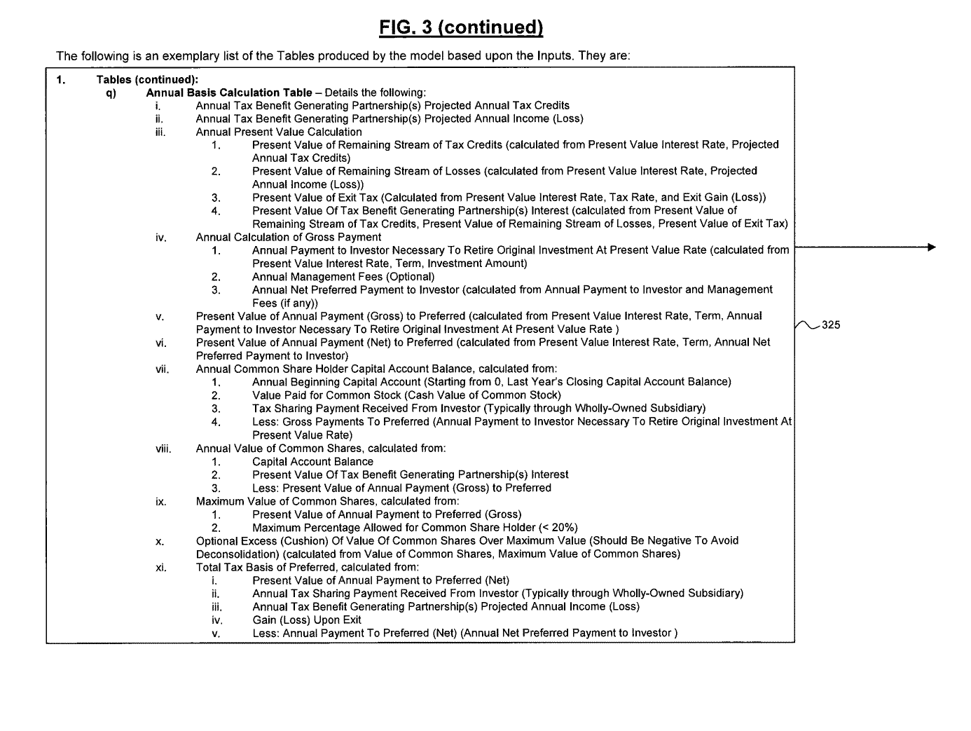

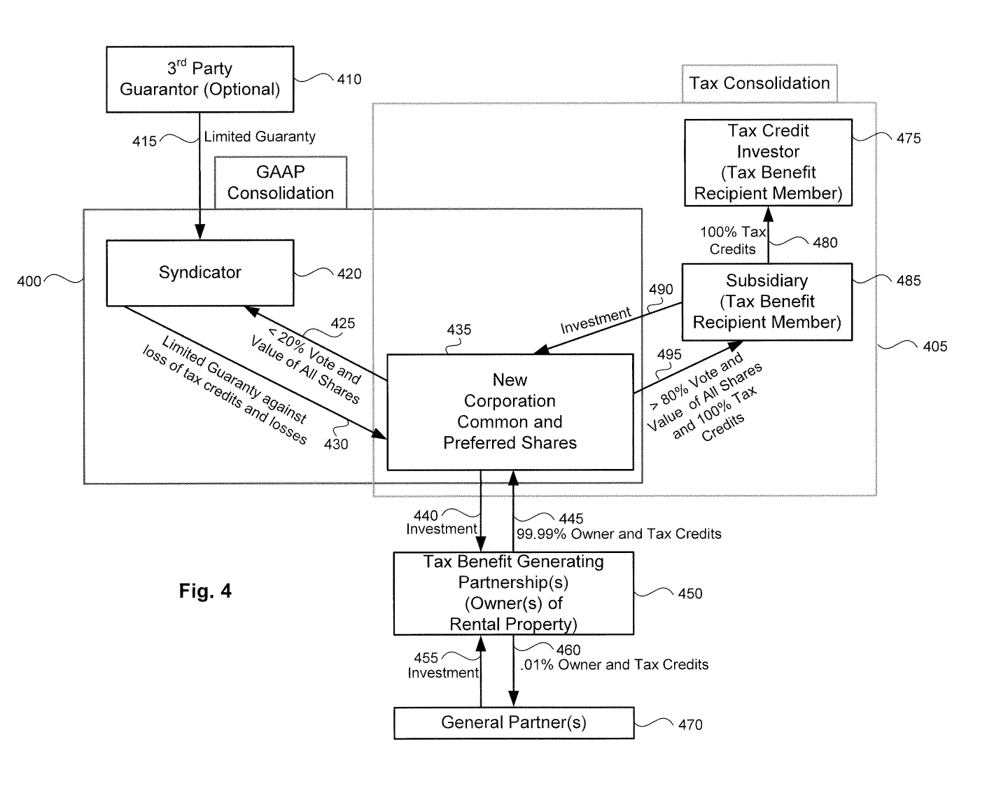

Once collected in steps 100 and 105, in step 110 the inputs may be compiled into a computer software model, such as for example a spreadsheet program like Microsoft Excel. In step 115, the computer program or user chooses from among various structural alternatives and terms for the preferred stock and common stock in Newco Corporation and the amount of the required guaranty by Syndicator (or third-party guarantor). Each alternative determines the type of calculations performed upon the input data assumptions. The alternatives may be chosen in step 115 by the computer alone or by the user after presentation of the various alternatives, in any convenient manner. FIGS. 4-7 detail embodiments wherein these structuring alternatives are displayed as choices available to the user. For example, the basic legal structure may either be a single project or a series of projects, and the project or projects may generate a gain or loss for federal income tax purposes upon the exit of the investor from the Newco Corporation. A user may choose between these by selecting one or the other.

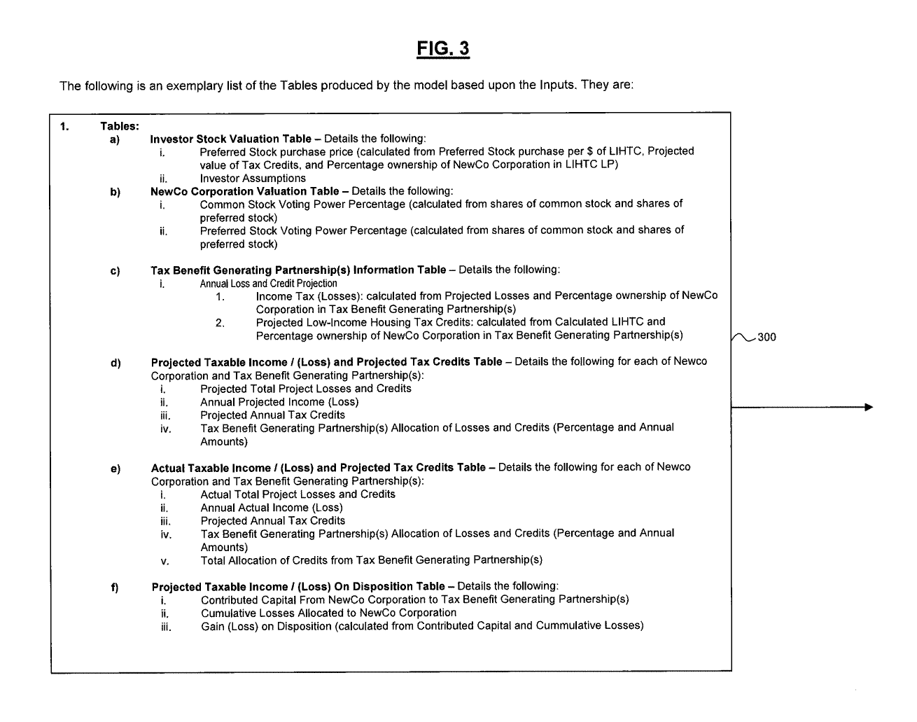

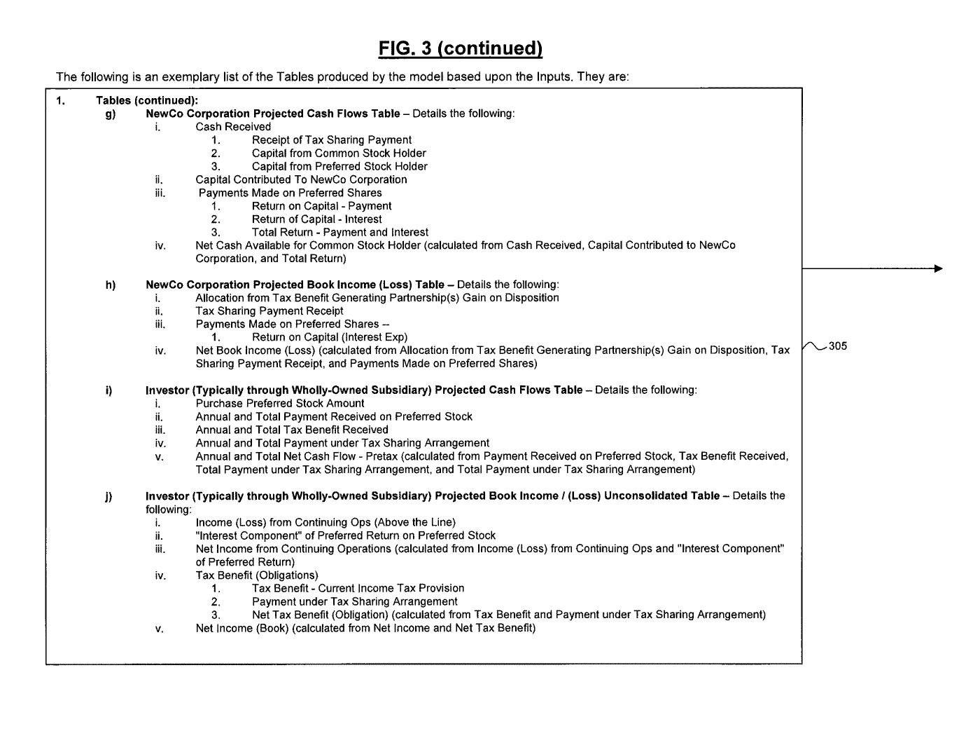

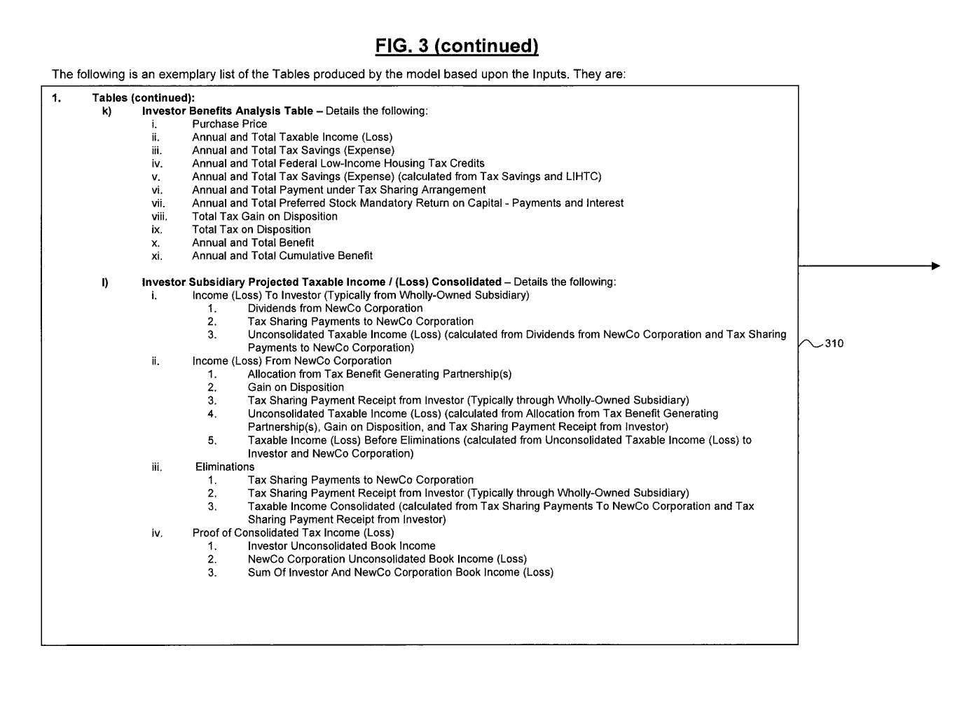

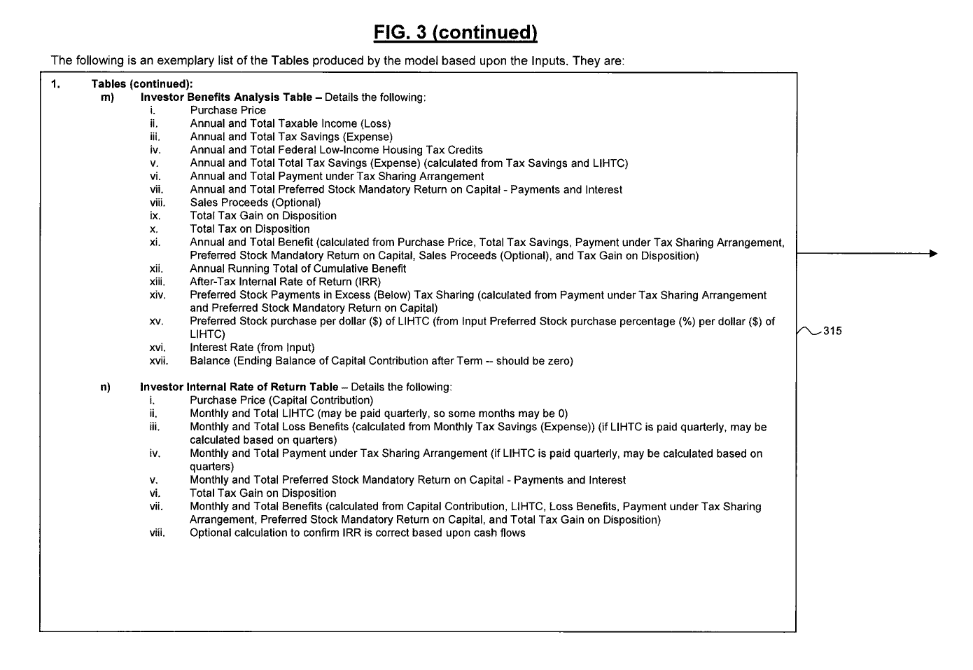

In step 120 the computer software program performs the calculations upon the inputs, according to the calculation model associated with the chosen structural alternatives. According to one embodiment, these calculations may be performed in a spreadsheet program, for example in Microsoft Excel. Illustrative calculations are shown in FIG. 3. Once the calculations have been performed, in step 125 the computer program outputs the data generated by the model in a human-readable format, for example as graphs, charts, and/or tables. Illustrative outputs in step 125 are shown in FIG. 3. Outputs may include those that track the schedule of dividend payments on the investor's preferred stock in Newco Corporation, tax benefits and intended yield (usually determined on an internal rate of return basis), the amount of ownership allocations to the Syndicator and Investor required to avoid GAAP deconsolidation (in the case of the Syndicator) and tax deconsolidation (in the case of the investor), the size of the Syndicator (or third-party) guaranty required to the investor, and calendar-term-defined projections of the above.

In step 130, the information outputted in step 125 is examined to verify that it satisfies existing Internal Revenue Code, Treasury Regulation, and Financial Accounting Standards Board (FASB) rules. If the answer is no, step 115 may be repeated and the structural alternatives may be varied to produce different results. If the model output does comply with Internal Revenue Code, Treasury Regulation, and FASB rules, then the output is presented to the syndicator, the investor and the developer for consideration in step 135. Again, if either the investor, the syndicator or the developer does not agree upon the terms and outputs generated by the computer program, the inputs or structural alternatives may be varied to produce different results. If the syndicator and developer do agree on the structure proposed by the model outputs, these are applied as the foundation for the project structural model in step 140.

FIG. 4 depicts a structure for holding project assets according to an embodiment of the present invention, reflected in documents generated and executed by two or more of the General Partner 470 (typically the project developer), the Syndicator 420 and the tax credit investor 475 (typically through a subsidiary 485). The documents specify the allocation of shares in a New Corporation 435 to the Syndicator 420 and the tax credit investor 475, and specify the entrance of the General Partner(s) 470 and the New Corporation 435 into a partnership or partnerships 450 (the tax-benefit generating entity or entities) that holds the physical rental properties. For example, the agreement may specify that the General Partner(s) 470 agrees to take a minimal share 460 in the partnership 450 (and therefore receive minimal tax credits), in return for an investor making an investment 455 in the project. The New Corporation 435 will acquire the limited partnership interests in the partnership(s) 450. The investment 440 required to fund the partnership(s) 450 is agreed upon as follows.

The tax credit investor 475, typically through a wholly-owned subsidiary 485, invests 490 in the New Corporation, which provides the funding 440 to the partnership 450. In return, the subsidiary 485 receives more than 80% of the voting rights and value of all of the shares in the New Corporation and also receives all of the tax credits and other tax benefits (depreciation losses) the New Corporation receives from the partnership 495. The subsidiary may transfer 100% of the tax credits and tax benefits it receives to its parent 480. The investor 475, subsidiary 485, and New Corporation 435 are all considered consolidated for federal income tax purposes 405 as described above.

In return for less than 20% of the voting rights and value of all shares 425 in the New Corporation 435, the Syndicator 420 contributes cash and agrees to provide the New Corporation a guaranty against the expected loss of the tax credits and other losses 430 as described above. A third-party guarantor 410 may optionally provide a limited guaranty 415 to the Syndicator 420. The Syndicator 420 and the New Corporation 435 are considered to be consolidated for financial accounting (GAAP) purposes 400 as described above.

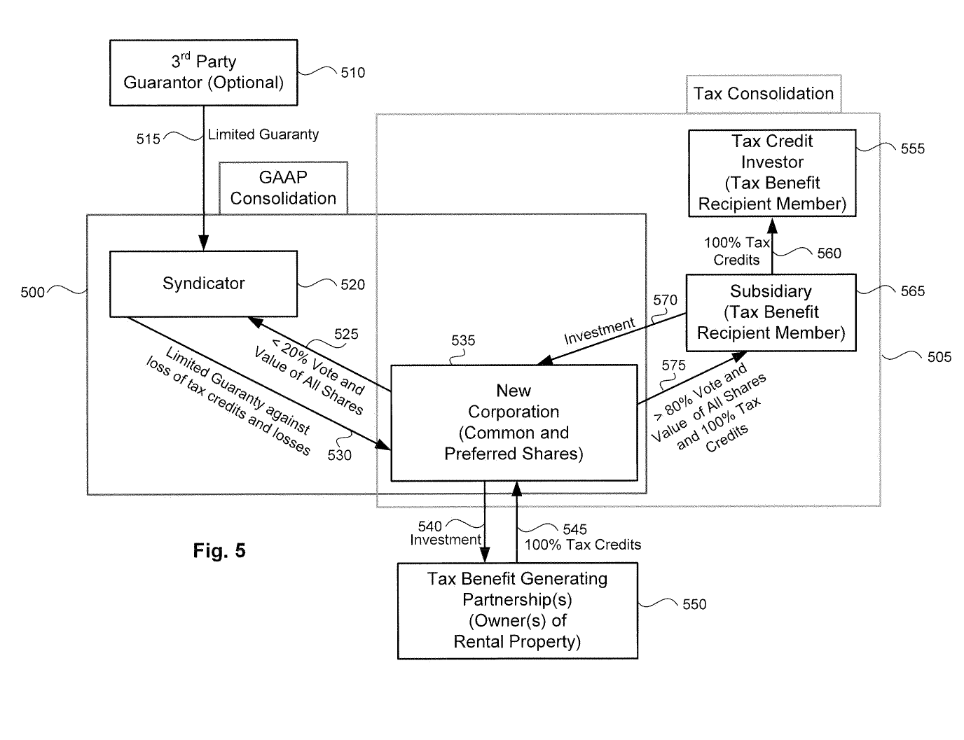

FIG. 5 depicts a structure for holding project assets according to an embodiment of the present invention, reflected in documents generated and executed by two or more of the Tax Benefit Generating Partnership(s) 550, the Syndicator 520 and the tax credit investor 555. The documents specify the allocation of shares in a New Corporation 535 to the Syndicator 520 and the tax credit investor 555 (typically through a subsidiary 565), and specify the structure of the Tax Benefit Generating Partnership(s) 550 and the entrance of the New Corporation 535 into the partnership or partnerships 550 (the tax-benefit generating entity or entities) that holds the physical rental properties. For example, The New Corporation 535 will acquire the limited partnership interests in the partnership(s) 550. The investment(s) 540 required to fund the partnership(s) 550 are agreed upon as follows.

The tax credit investor 555, typically through a wholly-owned subsidiary 565, invests 570 in the New Corporation, which provides the funding 540 to the partnership 550. In return, the subsidiary 565 receives more than 80% of the voting rights and value of all of the shares in the New Corporation and also receives all of the tax credits the New Corporation receives from the partnership 575. The subsidiary may transfer 100% of the tax credits it receives to its parent 560. The investor 555, subsidiary 565, and New Corporation 535 are all considered consolidated via the consolidated return rules for federal income tax purposes 505 as described above.

In return for less than 20% of the voting rights and value of the shares 525 in the New Corporation 535, the Syndicator 520 agrees to provide the New Corporation a guaranty against the expected loss of the tax credits and other tax benefits 530 as described above. A third-party guarantor 510 may optionally provide a limited guaranty 515 to the Syndicator 520. The Syndicator 620 and the New Corporation 535 are considered to be consolidated for financial accounting (GAAP) purposes 500 as described above.

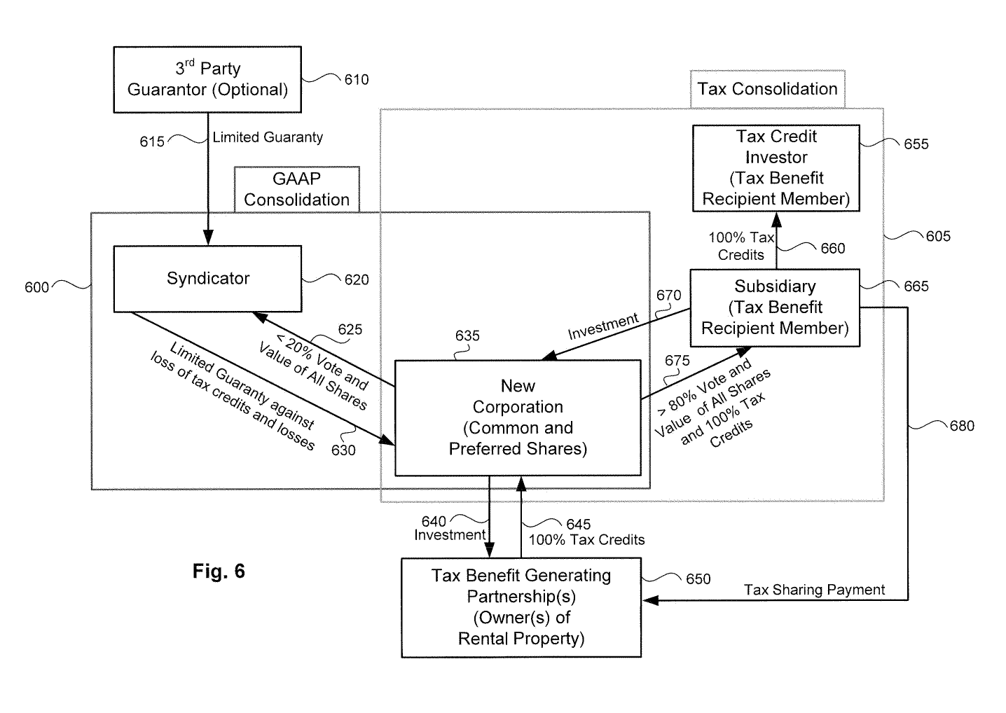

FIG. 6 depicts a structure for holding project assets according to an embodiment of the present invention, reflected in documents generated and executed by two or more of the Tax Benefit Generating Partnership(s) 650, the Syndicator 620 and the tax credit investor 655. The documents specify the allocation of shares in a New Corporation 635 to the Syndicator 620 and the tax credit investor 655 (typically through a subsidiary 665), and specify the structure of the Tax Benefit Generating Partnership(s) 650 and the entrance of the New Corporation 635 into the partnership or partnerships 550 (the tax-benefit generating entity or entities) that holds the physical rental properties. For example, The New Corporation 635 will take the majority share in the partnership(s) 650. The investment 640 required to fund the partnership(s) 650 are agreed upon as follows.

The tax credit investor 655, typically through a wholly-owned subsidiary 665, invests 670 in the New Corporation, which provides the funding 640 to the partnership 550. In return, the subsidiary 665 receives more than 80% of the voting rights and value of all of the shares in the New Corporation and also receives all of the tax credits and other tax benefits the New Corporation receives from the partnership 675. The subsidiary transfers 100% of the tax credits and other tax benefits it receives to its parent pursuant to the consolidated return rules 660. The subsidiary may provide a tax sharing payment to the partnership 680, as described above. The investor 655, subsidiary 665, and New Corporation 635 are all considered consolidated for federal income tax purposes 605 as described above.

In return for less than 20% of the voting rights and value of the shares 625 in the New Corporation 635, the Syndicator 620 agrees to provide the New Corporation a guaranty against the expected loss of the tax credits and other tax benefits 630 as described above. A third-party guarantor 610 may optionally provide a limited guaranty 615 to the Syndicator 620. At least the Syndicator 620 and the New Corporation 635 are considered to be consolidated for financial accounting (GAAP) purposes 600 as described above.

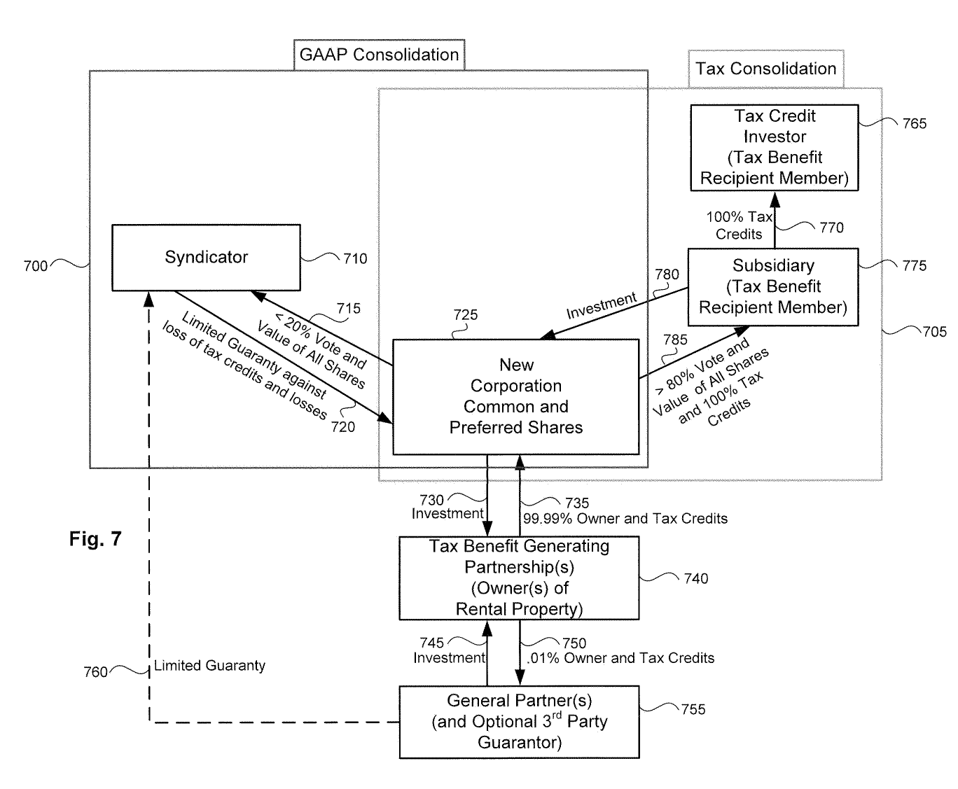

FIG. 7 depicts a structure for holding project assets according to an embodiment of the present invention, reflected in documents generated and executed by two or more of the General Partner 755 (typically the project developer), the Syndicator 710 and the tax credit investor 765. The documents specify the allocation of shares in a New Corporation 725 to the Syndicator 710 and the tax credit investor 765 (typically through a subsidiary 775), and specify the entrance of the General Partner(s) 755 and the New Corporation 725 into a partnership or partnerships 740 (the tax-benefit generating entity or entities) that holds the physical rental properties. For example, the agreement may specify that the General Partner(s) 755 agrees to take a minimal share 750 in the partnership 755 (and therefore receive minimal tax credits), in return for the investor making a significant financial investment 745 in the project. The New Corporation 725 will take the majority share in the partnership(s) 740. The investment 730 required to fund the partnership(s) 740 are agreed upon as follows.

The tax credit investor 765, typically through a wholly-owned subsidiary 775, invests 780 in the New Corporation, which provides the funding 730 to the partnership 740. In return, the subsidiary 775 receives more than 80% of the voting rights and value of all of the shares in the New Corporation and also receives all of the tax credits the New Corporation receives from the partnership 785. The subsidiary transfers 100% of the tax credits it receives to its parent pursuant to the consolidated return rules 770. The investor 765, subsidiary 775, and New Corporation 725 are all considered consolidated for federal income tax purposes 705 as described above.

In return for less than 20% of the voting rights and value if the shares 715 in the New Corporation 725, the Syndicator 710 agrees to provide the New Corporation a guaranty against the expected loss of the tax credits and other losses 720 as described above. The General Partner(s) 755 may optionally provide a limited guaranty 760 to the Syndicator 710. The Syndicator 710 and the New Corporation 725 are considered to be consolidated for financial accounting (GAAP) purposes 700 as described above.

Each of the software programs described herein may be stored in a computer usable medium, such as a memory, a hard disk drive, a CD ROM or DVD or on a database or other memory accessible over a network. During use, the software may be loaded into the memory of a general purpose computer or other device that includes, for example, a memory, a processor, a display, a network unit for connecting to the Internet or other network, input/output devices such as a keyboard, mouse and printer. The software programs include program instructions and data that when loaded in the memory are accessed, executed and used by the processor to carry out described method steps described herein, including allowing data and control inputs, running analyzes and creating and printing documents.

While particular embodiments of the present invention have been shown and described, it will be understood by those having ordinary skill in the art that changes may be made to those embodiments without departing from the spirit and scope of the present invention.

What is claimed is:

1. A method of assessing and effecting the transfer of federal tax credits generated by low-income housing projects to a recipient capable of utilizing the tax credits and losses, the method comprising:
identifying one or more housing projects with tax credits available for syndication;
determining a corporate structure for effecting the syndication of the tax credits;
determining the yield of the one or more projects;
determining terms of common stock and preferred stock in a new corporation, wherein the terms include a schedule of an investor's preferred stock in the new corporation such that the investor and the new corporation are consolidated for federal income tax purposes and the new corporation and a syndicator are consolidated for financial accounting purposes;
documenting enforceable agreements transferring value from the investor to the new corporation, transferring value from the new corporation to an owner of the one or more projects, and transferring at least a portion of the tax credits from the owner to the new corporation; and
at least partly carrying out said agreements.

2. The method of claim 1, wherein the terms include a dividend rate and;
the schedule is configured such that the investor receives a specified yield.

3. The method of claim 1, further comprising determining the amount of a guaranty to be provided by the syndicator necessary to ensure that the investor's investment in stock is treated as a debt instrument for financial accounting purposes.

4. The method of claim 3, further comprising the amount of the guaranty is further determined by value-based economic factors.

5. The method of claim 3, further comprising determining the amount of a guaranty to be provided by a guarantor to the syndicator.

6. The method of claim 1, further comprising determining the amount of a guaranty to be provided by a guarantor to the syndicator.

7. The method of claim 1, further comprising receiving project inputs; and
calculating the effects of value-based economic factors.

8. The method of claim 7, wherein the economic factors include cash flow, profits, capital gains, depreciation, and internal rate of return to the investor of the project.

9. The method of claim 7, wherein the calculations are used to optimize the agreements, including maximizing available syndicatable tax credits.

10. The method of claim 7, wherein the calculations are performed by a computer program.

11. A computer software program having computer program logic therein that causes a computer to:
receive inputs associated with the transfer of federal low-income housing tax credits generated by a low-income housing tax credit project; and
determine output related to economic factors that affect at least one of the syndicatability of the tax credits, the structure of corporations involved in the syndication of the tax credits, the terms of the preferred stock and common stock in a new corporation, the terms, amount and timing of the tax sharing payments to be made by an investor to the new corporation, and the form of documents and agreements.

12. The computer software program of claim 11, wherein the economic factors include cash flow, profits, capital gains, and intended internal rate of return of the project.

13. The computer software program of claim 11, further comprising computer program logic therein that causes a computer to perform calculations to optimize the corporate structure, including maximizing available syndicatable tax credits.

14. The computer software program of claim 11, wherein the inputs comprise one or more variables relating to at least one of the projects and the syndication of the tax credits.

15. The computer software program of claim 11, wherein the variables comprise one or more of development information, tax credit information, debt parameters, fair market value information, tax depreciation information, information relating to the expected loss performance of the projects, estimated gain or loss upon the departure of the investor from the new corporation, and cash flow projections.

16. The computer software program of claim 11, wherein the variables comprise one or more of total project development costs, tax credits, parameters of the debt, fair market value, tax depreciation, amortization of deferred costs, required yield on the tax credit investor, tax rate, ownership percentages, numbers of shares of stock, present value, term, and cash flow projections.

17. The computer software program of claim 11, further comprising computer program logic therein that causes a computer to allow a user to provide input regarding desired corporate structure.

18. The computer software program of claim 11, further comprising computer program logic therein that causes a computer to output models.

19. The computer software program of claim 18, wherein the models comprise at least one of graphs, charts, and tables.

20. The computer software program of claim 19, wherein the model conveys information about investor capital accounts, developer capital accounts, benefits to developers, 15-year projections of the net operating income, taxable income, and net cash flow, investor tax credit valuation, investor cash valuation, pricing and terms of the preferred stock and common stock in the new corporation, and the expected gain or loss upon the exit of the investor from the new corporation.
